(19) United States
(12) Patent Application Publication
(10) Pub. No.: US 2005/0058783 A1
(43) Pub. Date: Mar. 17, 2005

(54) Ornaments

(75) Inventor: Joshua William Johnson, West Midlands (GB)

Correspondence Address: CAESAR, RIVISE, BERNSTEIN,;COHEN & POKOTILOW, LTD., 11TH FLOOR, SEVEN PENN CENTER, 1635 MARKET STREET, PHILADELPHIA, PA, 19103-2212, US

(73) Assignee: The Potting Shed Pottery Limited, Kingswinford (GB)

(21) Appl. No.: 10/763,798

(22) Filed: Jan. 23, 2004

(30) Foreign Application Priority Data
Sep. 16, 2003 (GB) 0321673.6

(51) Int. Cl. A41G 1/00; A01N 3/00

(52) U.S. Cl. 428/17; 428/25

(57) ABSTRACT

An ornament 10 in the shape of a toadstool, mushroom or plant having a bell member 1 and a stalk member 2 interconnected by flexible connection means 7 which, in use, renders the bell member 1 moveable with respect to the stalk member 2. The ornament 10 may be for indoor or outdoor use.

Many ornaments are known which can be located in a garden. Gnomes are one common ornament type, although other creatures such as fairies and animals are also known. Ornaments which are to be located outdoors need to be resistant to environmental conditions such as rain, frost, sun. Consequently, they are usually fabricated from pottery which is fired at sufficient temperatures to render it non-porous and/or they are glazed with non-porous glazes. Other materials such as cement, concrete and wood may be used.

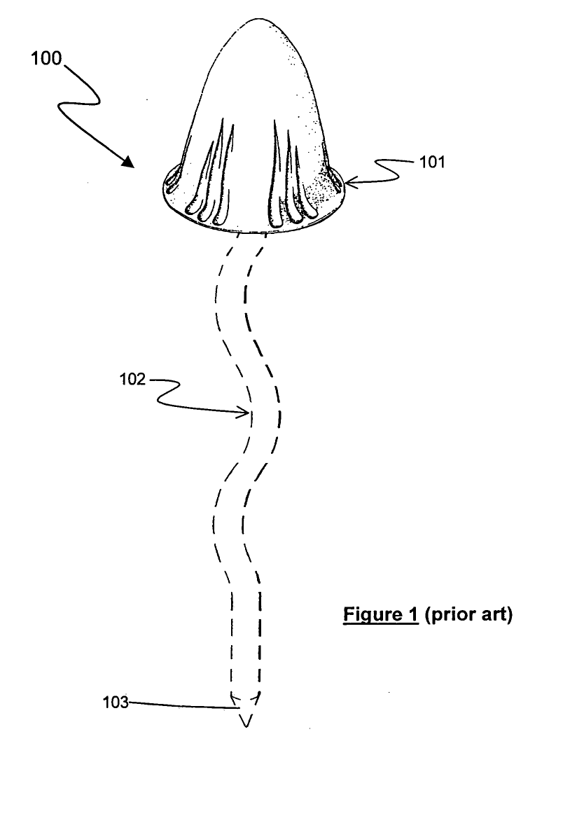

Ornaments based on fungi are known. For example, see our US Design Pat. No. 476254 (published 24 Jun. 2003) which shows a bell (nominally in the shape of a bell of a toadstool or mushroom) sitting atop a curved stalk (FIG. 1). The curved stalk has a point at its upper end on which the bell is supported, the bell thereby being free to pivot on, or rotate about the stalk, in the wind. When a plurality of such ornaments are placed in a cluster in close proximity, the wind can cause the bell of one to contact the bells or stalks of adjacent ornaments, thereby causing a chime effect. With such ornaments the bells may be fabricated from pottery to enhance the chiming or ringing effect.

The ornaments have some drawbacks. Firstly, the movement of the bell on the stalk is not always ‘life-like’ because the bell is supported on a spike. Secondly, in high winds the bell can be blown off of the stalk. Also, the stalk cannot stand upright on a flat impenetrable surface. A high level of force is required to embed the pointed end of the stalk in the ground if the soil or substrate into which it is to be forced is not sufficiently moist (a pottery ‘point’ is not very pointed). Fourthly, in larger versions it can be difficult for some people (for example, the physically impaired) to manipulate the stalk and force it into the ground, irrespective of the substrate conditions.

It is an object of this invention to provide a new ornament which has a more realistic action than those previously proposed. It is a further object to provide an ornament which avoids one or more of the above-discussed drawbacks which may be associated with prior art ornaments.

Accordingly, a first aspect of the invention provides an ornament in the shape of a fungus or plant, having a head member and a stalk member interconnected by flexible connection means which, in use, renders the head member moveable with respect to the stalk member.

A further, and/or more specific aspect of the invention, provides an ornament in the shape of a toadstool, mushroom or plant, having a head member and a stalk member interconnected by flexible connection means which, in use, renders the head member capable of restricted vertical movement with respect to the stalk member.

Preferably said flexible connection means is a spring, preferably formed from metal, advantageously stainless steel or other corrosion resistant metal. Said flexible connection means may alternatively comprise a hollow or solid plastics or rubber tube. In either or all cases, said flexible connection means is elongate with one end thereof connected to the stalk and the other end connected to the bell.

Preferably the stalk member is formed with or carries a connection part at a proximal end for attachment thereto of said flexible connection means. The stalk member connection part may be tapered and/or may comprise a screw thread.

Preferably, the underside of the head member is shaped as a bell which, at or about the apex thereof may have attached thereto a connection part for attachment thereto of said flexible connection means. The head member connection part or bell connection part may be tapered and/or may comprise a screw thread.

Preferably, the stalk member is hollow. The stalk member may have a socket at a distal end thereof.

The distal end of the stalk member may have an outwardly flared portion to provide a relatively wide base.

The ornament may further comprise a spike, one end of which is receivable in said socket and the other end of which defines a substrate-penetrating point which is forceable into the ground or other substrate on which the ornament is to be located.

Preferably the head member and the stalk member are made of pottery, fired to be non-porous. The head member and/or stalk member may be earthenware, stoneware or porcelain. One or both of the head member (e.g. bell) and the stalk member may be fabricated from other materials, such as metal, concrete, cement, glass, plastics or wood.

Preferably, the head member and/or the stalk member are cast and then fired.

The head member and/or the stalk member may be glazed with weather resistant glaze. The head member and/or stalk member may be glazed before firing (raw glazing) or after firing and then re-fired.

A further aspect of the invention provides a method of forming a plant-shaped or mushroom or toadstool-shaped garden ornament, the method comprising providing one or both of a head member and a stalk member and interconnecting the head member and the stalk member with flexible connection means such that the head member is moveable with respect to the stalk member.

A yet further aspect of the invention provides a kit of parts for an ornament, preferably an ornament suitable for use outdoors, the kit comprising one or more first parts in the shape of a first portion of a plant or fungus, one or more second parts in the shape of a second portion of a plant or fungus and one or more flexible connection means, a first and second part being inter-connectable by said flexible connection means.

A further aspect of the invention provides a plant or fungus-like ornament comprising a stalk member and a head member, said stalk member being, in use, substantially vertical, said head member being on the top end of the said stalk member, flexible connection means being present between the top of the said stalk member and an inside wall of said bell member, whereby said bell member is retained on said stalk member but is moveable under the influence of wind or like force.

A yet further aspect of the invention provides a stalk member in the shape of, or reminiscent of, a stalk of a mushroom or toadstool or stem of a plant, connectable at its one end to a head member, the other end terminating in a flat base portion having a socket to receive a spigot of a spike, the base portion being of wider diameter than the remainder of the stalk.

Preferably, the ornament is suitably weather resistant for use in the garden or other outdoors location.

In order that the invention may be more fully understood, it will now be described, by way of example only and with reference to the accompanying drawings, in which:

FIG. 1 is a prior art ornament;

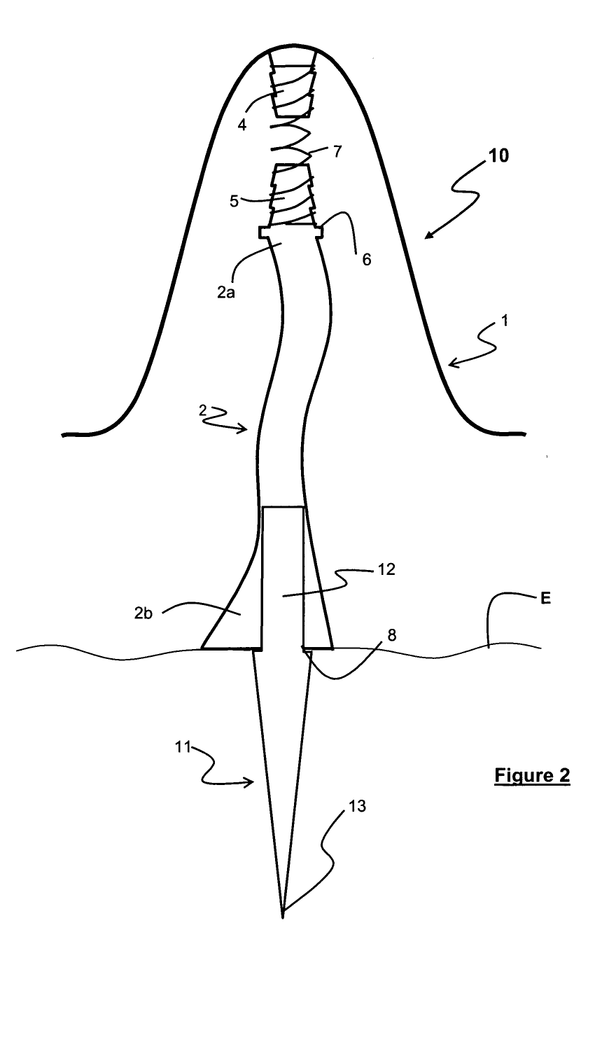

FIG. 2 is a vertical section through an ornament of the invention, received in soil;

FIG. 3 is a elevation view of a second ornament according to the invention; and

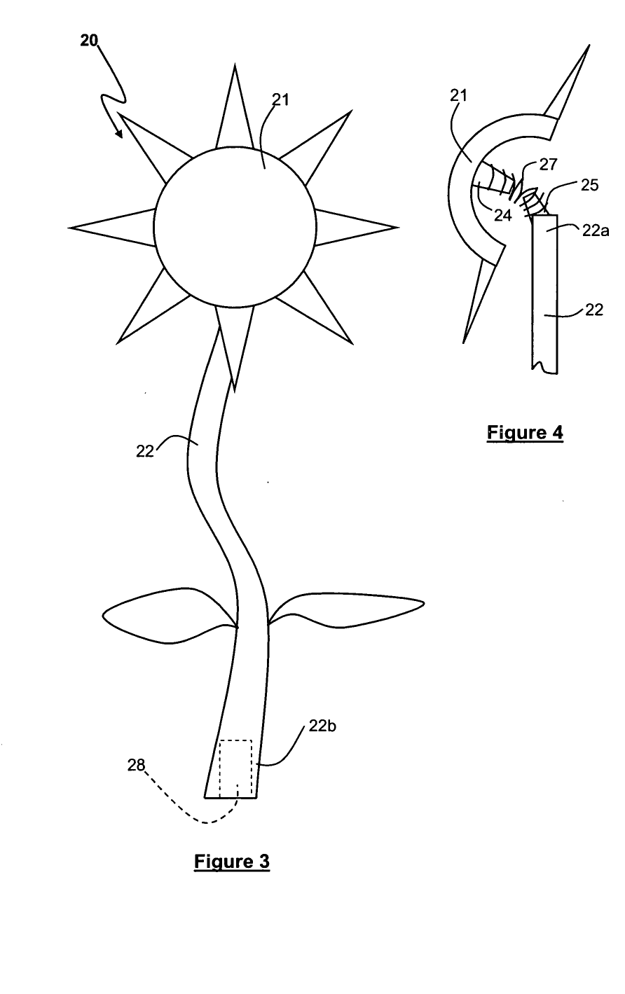

FIG. 4 is a sectional view of a the upper part of the ornament of FIG. 3.

FIG. 1 shows a prior art ornament 100 for a garden comprising a pottery bell 101 sitting atop a curved pottery stalk 102. Both ends of the stalk 102 are formed with points 103 (only one shown). The bell 101 has a dimple on the underside of its apex in which the upper point of the stalk 102 is located. The lower point 103 is forceable into a substrate, say earth or soil.

In use, the bell 101 is pivotable and rotateable on the upper point 103 of the stalk 102.

In use, and when installed in a garden, wind can cause the bell 101 to rock on the stalk 102. If the bell 101 contacts a bell or stalk of an adjacent ornament 100 it produces a ringing sound, like a wind chime.

FIG. 2 shows an ornament 10 having a head in the shape of a bell 1 and a hollow curved stalk 2 having intended upper 2a and lower 2b ends.

The bell 1 is cast and has a tapered screw portion 4 joined thereto, the portion 4 being located on the underside of the apex of the bell 1. The stalk 2 has a tapered screw portion 5 joined thereto at its upper end 2a. A ledge or shoulder 6 is present between the tapered screw portion 4 and the upper end 2a of the stalk 2.

A metal coiled spring 7 is wound around each of the tapered screw portions 4, 5, to interconnect the bell 1 to the stalk 2.

The lower end 2b of the stalk 2 has a socket 8 in which is removeably located a spigot 12 of spike member 11, the other end of the spike member 11 terminating in a ground-penetrating point 13.

To fabricate the ornament 10, the bell 1 and stalk 2 are cast from a ceramic slip as is well known. The tapered screw portions 4, 5 are separately cast from a ceramic slip or are moulded from clay. These are then left to dry to a ‘green condition’. Once the parts 1, 2, 4, 5 have dried sufficiently to be handleable, the bell screw portion 4 is attached to the bell 1 and the stalk screw portion 5 is attached to the ledge or shoulder 6 at the upper end 2a of the stalk 2 using further slip as an adhesive. The bell 1 and stalk 2 are then fired at 1180 to 1200° C. to ensure that the pottery is non-porous. The bell 1 and/or the stalk 2 are glazed and re-fired. Typically, the screw portions 4, 5 are not glazed.

The ornament 10 will usually be supplied as a kit made up of bell 1, stalk 2, spring 7 and plastics spike member 11. The spring 7 is screwed onto the bell tapered screw portion 4 and then the tapered screw portion 5 of the stalk 2 is screwed into the spring 7. The spring 7 is usually formed of metal, say stainless steel, although other materials may be used and is sized such that it has a diameter slightly smaller than that of the tapered screw portions 4, 5 whereby it grippingly engages said tapered screw portions 4, 5 when screwed thereon. When the screw portions 4, 5 are not glazed, and due to the disparity of diameters between the spring 7 and screw portions 4, 5, it is very difficult to unwind the spring 7 from the screw portions 4, 5 once installed thereon.

Indeed, with a spring 7 formed from about 1 mm diameter steel with 5.5 to 8 turns per 5 cm length, having an effective diameter of about 1.5 cm attached at either of its ends to screw portions 4, 5 1.5 cm long each having a screw pitch of 0.5 cm and tapering from 1.6 to 2.0 cm diameter it is very difficult to disconnect the parts 4, 5, 7. With such a spring 7 it has been found that the force retaining the spring 7 on the screw portions 4, 5 is greater than the ‘coil strength’ of the spring 7 such that when it is attempted to unwind or disconnect one part (say the stalk 2) form another (say bell 1), the ‘free’ part of the spring is caused to unwind or to attempt to unwind, rather than one end of the spring 7 unwinding from a screw part 4, 5 to which it is connected.

If the ornament 10 is to be used outside, the point 13 of spike member 11 is forced into the ground E and the ornament 10 (i.e. the socket 8 of the stalk 2) is placed over the spigot 12.

The use of the spike member 11 is advantageous because some of the larger prior art stalks 102 were up to eighteen inches long and were quite unwieldy and/or difficult to insert into earth. Also, when the spike is fabricated from metal or plastics, the point 13 of the spike member 11 can be made more ‘pointed’ than is possible with pottery spikes 103.

If the ornament 10 is to be located inside, the lower end 2b of the stalk is flared outwardly to be of sufficient size so that the ornament 10 can balance and stand upright on a flat surface, although it may also be located, for example, in a plant pot using the spike member 11.

Whilst a spring 7 is preferred, it may be replaced with a plastics or rubber tube or sleeve which fits over tapered portions on the bell 1 and stalk 2. Other resilient means may also be used. The spring 7 allows free movement of the bell 1 with respect to the stalk 2, providing a ‘natural-look’ swaying action of the bell 1 on the stalk 2. It will be appreciated that a spring 7 will allow the bell 1 to move vertically as well as pivotally in an arc about the axis of the spring 7. Thus the degrees of freedom of movement of the bell 7 are greatly improved over prior art ornaments 100.

If the bells 1 of adjacent ornaments 10 collide they chime. A plurality of ornaments 10 may be used to provide a display. The ornament 10 may be used with prior art ornaments 100 to provide a display.

One or both of the bell 1 and stalk 2 may be formed from materials other than pottery, for example concrete, cement, glass, wood, metal or plastics materials. The spike member 11 may be formed from metal, plastics or other suitable materials. Pottery may be used.

Whilst the description relates to ornaments which are reminiscent of fungi, other ornaments may be fabricated such as flowers, where the stalk is the stem of a flower and the ‘head’ is reminiscent of the head of a flower, as shown in FIGS. 3 and 4. For example, the ornament may be reminiscent of the shape of a flower 20 with flexible connection means 27 being mounted on an intended underside of the head or bloom 21 of the ornament 20 and an intended upper end 22a of the stem 22. The intended lower end 22b of the stem 22 may be formed with a ground-penetrating spike or may have a socket 28 into which a spike member 11 is insertable. The head 21 is moveable vertically with respect to the substrate on or in which the ornament 20 is located as well as being able to move in a side-to-side swaying motion. The head 21 and/or stem 22 of the ornament 20 may be formed from pottery (e.g. earthenware, stoneware, porcelain), metal, plastics, glass, cement, concrete or wood.

If, for example, the head were to be in the shape of a tulip bloom or other flower bloom, it may be mounted such that its equilibrium position is aligned with the principal axis of the stem part.

If the ornament is to be used outdoors it will be preferably formed of a material which is substantially impervious or resistant to weathering, pottery being preferred.

When formed from pottery, the head 1, 21 and stalk 2, 22 parts of the ornament may be raw glazed and then fired.

One or both of the head 1, 21 and stalk 2, 22, parts of the ornament 10, 20 may carry further embellishment such as indicia, characterizations or other markings.

1. An ornament in the shape of a fungus or plant, having a head member and a stalk member interconnected by flexible connection means which, in use, renders the head member moveable with respect to the stalk member.

2. An ornament according to claim 1, wherein said flexible connection means is elongate with one end thereof connected to the stalk member and the other end connected to a wall of the head member.

3. An ornament according to claim 1, wherein said flexible connection means is a spring.

4. An ornament according to claim 4, wherein the spring is stainless steel or other corrosion resistant metal.

5. An ornament according to claim 1, wherein said flexible connection means comprises a hollow or solid plastics or rubber tube.

6. An ornament according to claim 1, wherein the stalk member carries a connection part at a proximal end thereof to which said flexible connection means is connected.

7. An ornament according to claim 6, wherein the stalk member connection part is tapered and comprises a screw thread.

8. An ornament according to claim 1, wherein the head member is curved or dome-like and the intended underside thereof, at or about the apex thereof, carries a connection part for attachment thereto of said flexible connection means.

9. An ornament according to claim 8, wherein the head member connection part is tapered and/or comprises a screw thread.

10. An ornament according to claim 1, wherein the stalk member has a socket at an intended distal end thereof.

11. An ornament according to claim 1, wherein one end of the stalk member has an outwardly flared portion to provide a relatively wide base.

12. An ornament according to claim 10, further comprising a spike, one end of which is receivable in said socket and the other end of which defines a substrate-penetrating point which is forceable into the ground or other substrate on which the ornament is to be located.

13. An ornament according to claim 1, wherein one or both of the head member and the stalk member are made of pottery, fired to be non-porous.

14. An ornament according to claim 1, wherein the head member and/or the stalk member are glazed with weather resistant glaze.

15. An ornament according to claim 1, wherein said flexible connection means, in use, renders the head member capable of restricted vertical movement with respect to the stalk member.

16. An ornament according to claim 15, wherein said flexible connection means is elongate with one end thereof connected to the stalk member and the other end connected to the head member.

17. A method of forming a plant-shaped or mushroom or toadstool-shaped garden ornament, the method comprising providing a head member and a stalk member and interconnecting the head member and the stalk member with flexible connection means such that the head member is moveable with respect to the stalk member.

18. A kit of parts for a garden ornament, the kit comprising one or more first parts in the shape of a first portion of a plant or fungus, one or more second parts in the shape of a second portion of a plant or fungus and one or more flexible connection means, a first and second part being inter-connectable by said flexible connection means.

19. An plant or fungus-like ornament comprising a stalk member and a head member, said stalk member being, in use, substantially vertical, said head member being on the top end of the said stalk member, flexible connection means being present between the top of the said stalk member and an inside wall of said bell member, whereby said bell member is retained on said stalk member but is moveable under the influence of wind or like force.
